(19) United States
(12) Patent Application Publication
(10) Pub. No.: US 2017/0193066 A1
(43) Pub. Date: Jul. 6, 2017

(54) DATA MART FOR MACHINE LEARNING

(71) Applicant: LinkedIn Corporation, Mountain View, CA (US)

(72) Inventors: Qiang Zhu, Sunnyvale, CA (US); Yan Liu, Sunnyvale, CA (US); Songtao Guo, Cupertino, CA (US); Shaobo Liu, Shanghai (CN); Guan Wang, San Jose, CA (US); Sui Yan, Sunnyvale, CA (US); Kuisong Tong, San Jose, CA (US)

(21) Appl. No.: 14/986,599

(22) Filed: Dec. 31, 2015

(51) Int. Cl. G06F 17/30; G06F 17/50; G06N 99/00

(52) U.S. Cl. CPC G06F 17/30563; G06N 99/005; G06F 17/5009

(57) ABSTRACT

Techniques are provided for generating and deploying a computer model with few inputs from a user. Techniques are also provided for creating a data mart that multiple computer models may leverage in order to decrease the time required to generate subsequent computer models.

### CROSS-REFERENCE TO RELATED APPLICATIONS; BENEFIT CLAIM

This application is related to U.S. patent application Ser. No. ______ [Attorney Docket No. 60352-0148], concurrently filed herewith and incorporated herein by reference as if fully disclosed herein.

### BACKGROUND

A computer model is a set of algorithms and/or equations used to predict a real-world phenomenon or event or to capture the behavior of a system. A computer simulation is the actual running of the program that contains the set of algorithms/equations. Simulation, therefore, is the process of running a model. The process of developing a computer model is referred to as computer modeling. Computer models are used in many disciplines, such as the natural sciences (e.g., physics, biology, earth science, meteorology), engineering (e.g., computer science, artificial intelligence), and social sciences (e.g., economics, psychology, sociology, political science). Physicists, engineers, statisticians, operations research analysts, and economists use computer models extensively. A computer model may help to explain a system, study the effects of different components, and make predictions about behavior.

However, creating a computer model can be quite difficult and time-consuming. An end user who is responsible for building a computer model is required to manually build the model generation and deployment pipeline, including label preparation, feature generation, feature integration, feature engineering, data partition, model training/selection/validation, model deployment, and scheduling.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for automatically generating and, optionally, deploying one or more computer models, in an embodiment;

FIG. 2 is a flow diagram that depicts an example process for generating and deploying a computer model, in an embodiment;

FIG. 3 is a flow diagram that depicts a process for building and using a data mart, in an embodiment;

FIGS. 4A-4F are screenshots of example user interfaces, in an embodiment

FIG. 5 is a flow diagram that depicts a process for generating a computer model, in an embodiment;

FIG. 6 is a block diagram that depicts an example workflow of a project that is automatically created based on one or more user inputs, in an embodiment;

FIG. 7 is a flow diagram that depicts a process for applying a feature engineering strategy to a set of feature values, in an embodiment;

FIG. 8A is a block diagram that depicts an overview of refreshing a computer model, in an embodiment;

FIG. 8B is a chart that depicts performance of three example models over time: a baseline (or initial) model, a champion model, and a challenger model;

FIG. 9 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system for generating a computer model is described herein. In one technique, a data mart from which multiple computer models may be generated is created. The data mart is a result of extracting and aggregating data from one or more data sources. The data mart may be shared among multiple users so that each user is not required to manually extract and aggregate the data.

In another technique, features are automatically engineered to expand the number of features upon which a computer model is built.

In another technique, multiple parameters are pre-defined and used to automatically train multiple computer models. Each computer model is validated to determine which computer model performs the best according to one or more performance metrics. The computer model exhibiting the best performance is selected for deployment.

In another technique, once a computer model is trained and selected, the computer model is automatically deployed to a computer system for offline or real-time analysis against “current” data.

In another technique, a computer model is automatically refreshed in that a new computer model is generated and the relative performance of the old and new models is determined to determine whether to use the new model in place of the old model.

While techniques are described in the context of users of an online computer system, embodiments are not so limited. The computer models that are described herein may be user to predict not only human behavior, but also behavior of other entities (e.g., animals, plants, business organizations, governments), as well as predicting events, such as weather events, financial events, etc.

### System Overview

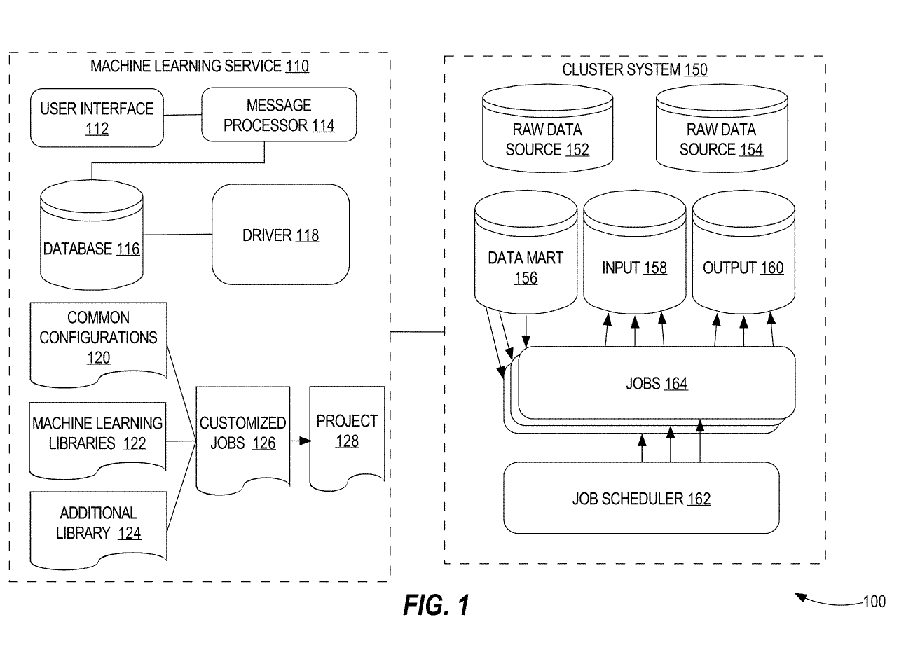

FIG. 1 is a block diagram that depicts an example system 100 for automatically generating and, optionally, deploying a computer model, in an embodiment. In some embodiments, a computer model is generated with only one or a few inputs from a user.

System 100 comprises a machine learning (ML) service 110 that interacts with cluster system 150 to generate and execute computer models. ML service 110 includes a user interface 112, a message processor 114, a database 116, a driver 118, common configurations data 120, machine learning libraries 122, additional library 124, customized job 126, and project 128, each of which is described in detail herein. While a relatively few functional and non-functional elements are described, ML service 110 may comprise more or fewer elements. For example, operations or functions performed by a single functional element (e.g., driver 118) may be separated and performed by multiple elements.

Each functional element in ML service 110 is implemented in hardware, software, or a combination of hardware and software. For example, each functional element includes software instructions that, when executed by one or more hardware processors, cause the functions described herein to be performed.

Cluster system 150 includes raw source data 152 and 154, data mart 156, input 158, output 160, a job scheduler 162, and jobs 164. Although not depicted, cluster system 150 includes a cluster of multiple computing machines or devices that run distributed processing software, such as Apache Hadoop. The (e.g., Hadoop) cluster executes jobs 164 sequentially or in parallel. Also, raw data sources 152-154 may be a part of cluster system 150 in addition to or instead of ML service 110.

Although not depicted in FIG. 1, one or more client devices connect to ML service 110 to either create data mart 156 or initiate generation of one or more computer models. Example client devices include laptop computers, tablet computers, desktop computers, and smartphone devices.

Each client device communicates with ML service 110 over a network, which may be implemented on any medium or mechanism that provides for the exchange of data between the client devices and ML service 110. Examples of such a network include, without limitation, a network such as a Local Area Network (LAN), Wide Area Network (WAN), Ethernet or the Internet, or one or more terrestrial, satellite or wireless links, such as a cellular network.

### Social Network Context

In a social networking context, system 100 is provided by a social network provider, such as LinkedIn, Facebook, or Google+. In this context, system 100 includes an account database that comprises information about multiple accounts. Each account includes a user profile that includes data provided by a different user. A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the user has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider).

Some data within a user's profile (e.g., work history) may be provided by the user while other data within the user's profile (e.g., skills and endorsement) may be provided by a third party, such as a “friend,” connection, or colleague of the user.

System 100 may prompt users to provide profile information in one of a number of ways. For example, system 100 may have provided a web page with a text field for one or more of the above-referenced types of information. In response to receiving profile information from a user's device, system 100 stores the information in an account that is associated with the user and that is associated with credential data that is used to authenticate the user to system 100 when the user attempts to log into system 100 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill. The data is stored in one or more of raw sources 152-154.

Continuing with the social network context, system 100 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by system 100 (or another automatic process). For example, a user specifies, in his/her profile, a name of the user's employer. System 100 determines, based on the name, where the employer and/or user is located. If the employer has multiple offices, then a location of the user may be inferred based on an IP address associated with the user when the user registered with a social network service (e.g., hosted by system 100) and/or when the user last logged onto the social network service.

As noted previously, while many examples herein are in the context of social networking, embodiments are not so limited.

### Example Process

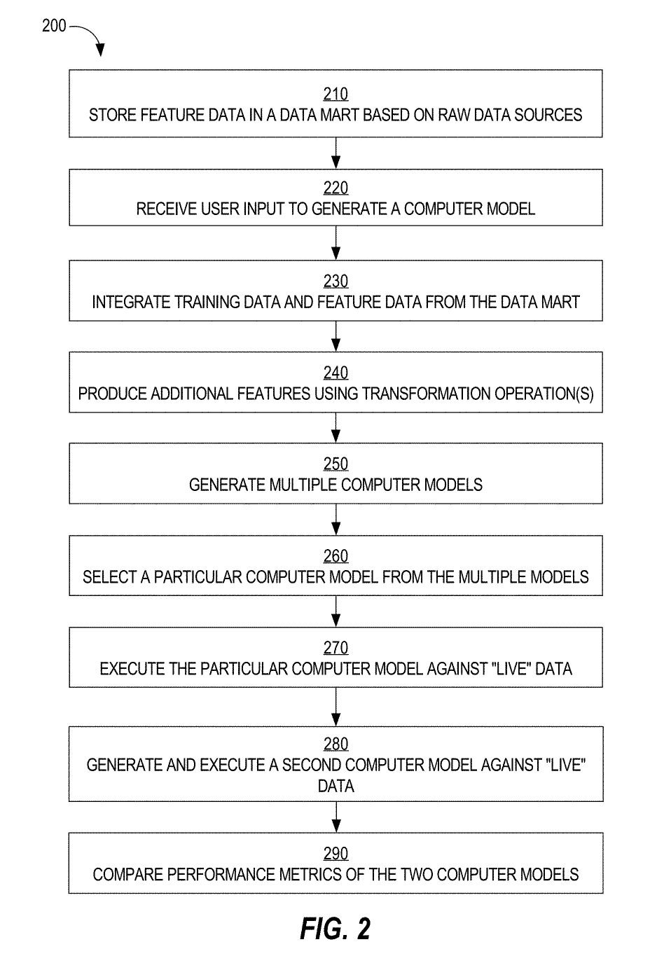

FIG. 2 is a flow diagram that depicts an example process 200 for generating and deploying a computer model, in an embodiment. Process 200 may be implemented by different components of system 100. Each block in process 200 is described in more detail herein.

At block 210, one or more jobs 164 are created and executed to generate data mart 156 based on raw data sources 152-154. For example, in the social networking context, raw data may include profile data of multiple profiles created by different users and activity data that indicates behavior of multiple users relative to an online system. The raw data is analyzed to identify and generate data to include in data mart 156. The one or more jobs 164 may be specified by a user interacting with ML service 110 through user interface 112 or may be specified by a user and transmitted directly to job scheduler 162.

At block 220, user interface 112 receives user input that indicates an intention to generate a computer model. The user input may specify a problem domain, which may be used to select an appropriate data mart from which to generate a computer model, if multiple data marts exist. For example, problem domain A (e.g., identifying users who are most likely purchase a particular service) is associated with a first data mart from which to generate computer models and problem domain B (e.g., predicting which members are real people rather than bots) is associated with a second data mart from which to generate computer models.

At block 230, in response to receiving the user input, feature data in data mart 156 is integrated with training data resulting in a data set from which a computer model may be generated. Block 230 may involve driver 118 generating a job that, after being sent to job scheduler 162 via an API call and while executed by cluster system 150, reads training data (which may be indicated in the user input of block 220 and read in from input 158) and combines the training data with different types of feature values read from data mart 156. A result indicating success of the job may be sent to message processor 114 of ML service 110. If so, then user interface 112 may be updated to indicate, to the user, progress on building the computer model(s). If an error occurs as a result of performing block 230, then the user may be so notified via message processor 114 and user interface 112.

At block 240, additional features and their corresponding values are produced using one or more transformation operations. Block 240 may involve cluster system 150, while executing a job (e.g., a newly generated job by ML service 110 or a portion of the job generated previously in block 230), reads (at least a portion of) the integrated data created in block 230 and applies the transformation operations. A result indicating failure (if one occurs) of the job may be sent to ML service 110. The additional features are stored to output 160 and leveraged later for model training. Optionally, block 240 may involve sending, to ML service 110, a location or path of where the intermediate results are stored, which storage may reside in cluster system 150. This option is relevant in a scenario where ML service 110 generates a separate job that will generate one or more computer models based on the features stored in output 160.

At block 250, one or more computer models are generated. Block 250 may be viewed as the training phase. Block 250 may involve cluster system 150, while executing a job (e.g., a newly generated job by ML service 110 or a portion of the job generated previously in block 230), generating and training the one or more computer models based on the feature values generated previously, which are read in as input 158 during execution of the job. Block 250 also involves validating each computer model, resulting in one or more performance metrics for each validation. The performance metrics are either stored to output 160 or sent to ML service 110. A result indicating success of the job may be sent to ML service 110. The one or more trained computer models are stored as output 160.

At block 260, a particular computer model from among multiple computer models (if multiple were generated) is selected. Block 260 may be viewed as the validation phase. The selection is based on one or more performance metrics (associated with each generated computer model) determined in this validation phase. Thus, the best performing computer model (as it pertains to the performance metric(s) may be selected. Block 260 may involve driver 118 selecting the computer model based on performance metrics that are stored to output 160 or sent directly to ML service 110. Alternatively, block 260 may involve cluster system 150 executing a job (e.g., a newly generated job by ML service 110 or a portion of the job generated previously in block 230), which causes a determination of which computer model performed the best. A model identifier that identifies the selected computer model is stored (e.g., to output 160).

Block 260 may also involve testing the selected computer model (e.g., a testing phase that is subsequent to the validation phase) based on a portion of the training data (which portion was not used previously to train the computer model(s)) to determine whether the selected computer model performed sufficiently well. If not, then process 200 may end or another validated computer model that was previously generated in block 250 may be selected for testing.

At block 270, the selected computer model is deployed. Block 270 may involve cluster system 150 executing a job (e.g., a newly generated job by ML service 110 or a portion of the job generated previously in block 230), which causes the first computer model to be executed against a data set (or “live” data), such as data from input 158, which may comprise records of many member accounts that serve as input to the selected computer model. Results of applying the selected computer model against the data set are stored to output 160.

At block 280, in response to determining that one or more criteria are satisfied (e.g., the passage of a certain amount of time), ML service 110 automatically causes a second computer model to be generated and deployed using blocks 220-270, i.e., based on data mart 156, which, at the time block 280 occurs, may store feature data that is different than the feature data upon which the first selected computer model was generated and trained. The second computer model is executed against a portion of “live” data, another portion of which the first computer model is being executed against. Results of executing a job corresponding to the second computer model are stored to output 160.

At block 290, in response to determining that one or more criteria are satisfied (e.g., the passage of a certain amount of time), cluster system 150 (or ML service 110) analyzes results of the first selected computer model and the results of the second computer model to generate a performance metric for each, such as a conversion rate. Block 290 may involve executing a job generated by ML service 110, sending the job (e.g., via an API call) to job scheduler 162, and cluster system 150 executing the job. The job either compares the two conversion rates to determine which conversion rate is higher or reports the two conversion rates to ML service 110. A result of block 290 may involve discard one of the two computer models or retaining them both for further analysis, but the allocation of “live” data to the two computer models may change, such as from 95/5 to 80/20.

Process 200 may be performed with just the two user inputs in blocks 210 and 220.

### Data Mart For Data Mining

In one scenario, raw data sources 152-154 are sources of data pertaining to information about one or more individuals or online accounts. In other scenarios, the data in raw data sources 152-154 may pertain to animals, astronomy, ecosystems, or the weather.

In the former scenario, raw data sources 152-154 may include user profiles or account information, such personal information and/or business information. Example personal information includes first and last names, current residence, marital status, personal interests. Example business information may include academic history, work history, employer name, job title, employment status, skills, and endorsements by other users or members of a social network. Such account information may or may not include any change information, such as data that indicates when the work history was changed, when the employment status changed, when the job title changed, etc.

Additionally or alternatively, raw data sources 152-154 include change information, such as when a user sent an invitation to connect (in a social graph) to another user, when a user sent a message to another user, when a user received a message to another user, when a user visited a particular page, when a user purchased a particular product or service, when a user commented on an online posting from another user, when a user was restricted from performing certain actions (such as accessing certain web pages, logging in, or commenting on other users' online postings), when a user was contacted by a recruiter, and when a user registered with a web site. Each change may be reflected in a separate record, which may be stored as a row in a relational table, an object in an object-oriented database, an entry in a file stored in a file system, or any other type of stored data item. The number and types of changes that are captured may vary greatly from one problem domain to another.

Traditionally, a user who wishes to create a computer model must specify a query that extracts certain data from raw data sources 152-154. Once extracted, the query (or another user statement) specifies how a portion of the extracted data is to be aggregated or combined. For example, a query may extract all change records that indicate that a message was sent from one user to another during the previous week. The user then specifies an aggregation operation that, when performed against the extracted change records, aggregates the change records on a per-user, per-week basis. Thus, if a particular user sent three messages during the previous week, then a result of the aggregation operation with respect to the corresponding three change records is a single record that indicates that the particular user sent three messages during the previous week. The user later submits commands that integrate the aggregated data with other data, including training data that is used to ultimately train a computer model. Therefore, the user must be familiar with how the underlying data is stored and what information to extract.

In an embodiment, a user with knowledge of the problem domain specifies what data to extract from raw data sources 152-154 and how the data is to be aggregated, if at all. The extracted and aggregated data is stored in data mart 156. Thus, data mart 156 may be considered a post-processing output of raw data sources 152-154. Another user provides input that initiates generation of a computer model that will be generated based on data in data mart 156. That other user does not need to know anything about how the raw data is stored or what data to retrieve and does not have to specify an extract instructions. That other user is only required to know that s/he wants a model created.

To extract data from raw data sources 152-154, a user may specify one or more extract instructions that indicate what data to extract from the raw data and to include in data mart 156. An extract instruction may be to analyze profile data to determine whether, for each user of multiple users, the user changed his/her employment status and to store the result of the determination in data mart 156. Another extract instruction may be to analyze message activity data to determine a number of times each user of multiple users sent a message using a particular messaging application. Thus, multiple message records of a single user may need to be analyzed and aggregated to determine that number. Thus, an extract instruction may also involve an aggregation instruction.

Time may be an important input for an extract instruction. In extracting snapshot data, time refers to a timestamp indicating a particular state of data, such as a member's employment status at time X. In extracting aggregated data, time refers to a time range over which to aggregate a feature. For example, a number of messages that were sent between date X and date Y.

An example extract instruction is a SQL SELECT statement that selects specified columns from specified tables (i.e., in a FROM clause) and that may include one or more predicates specified in a WHERE clause and an aggregation clause, such as SUM.

In order to submit extract instructions, a user operating a client device (not shown) may interact with user interface 112 (or another user interface) that ML service 110 provides and through which the user enters or otherwise supplies (e.g., in a file) the extract instructions. The user interface passes the extract instructions to message processor 114, which initiates creation of a job that includes the extract instructions that are executed by cluster system 150 against raw data sources 152-154.

An example of data that is stored in data mart 156 as a result of one or more extract instructions and that reflects a snapshot in time is the following:

```
{
  ″member_sk″ : {
    ″long″ : 1212
  },
  ″date_sk″ : {
    ″string″ : ″2013-08-03″
  },
  ″sales_score″ : {
    ″double″ : 0.7474631389151891
  },
  ″recruiter_score″ : {
    ″double″ : 0.9949085075932868
  }
}
```

This data record identifies a particular member, a particular date, a sales score, and a recruiter score. Each score may be generated per day or per week (or less regularly) and may reflect the particular member's activity on that particular date or over a period of time that includes the particular date (e.g., the last week or month).

An example of data that may be stored in data mart 156 as a result of one or more extract instructions and that reflects aggregated data is the following:

```
{
  ″member_sk″ : {
    ″long″ : 1498
  },
  ″date_sk″ : {
    ″string″ : ″2013-08-03″
  },
  ″inmail_sent″ : {
    ″long″ : 3
  },
  ″inmail_sent_job_oppt″ : {
    ″long″ : 0
  },
  ″inmail_received″ : {
    ″long″ : 1
  },
  ″inmail_received_job_oppt″ : {
    ″long″ : 0
  }
}
```

This data record identifies a particular member, a particular date, a number of messages sent (i.e., 3), a number of messages pertaining to job opportunities sent (i.e., 0), a number of messages received (i.e., 1), and a number of messages pertaining to job opportunities received (i.e., 0).

One benefit of this approach is that users who desire to train and deploy a computer model are not required to specify what data is to be extracted and how that data is to be combined. Thus, such users are not required to have any knowledge of the raw data. Another benefit is that, beginning from when a user desires to train a new computer model, the time to do so is significantly reduced because the relevant data is already extracted and stored in data mart 156.

In an embodiment, multiple data marts exist, one for each problem domain. For example, one group of developers may be working on identifying users of an online system who are illegitimate. Evidence of illegitimate activity may be include “scraping” data from other users' profiles, creating fake accounts to invite a large number of members of a social network to be connected, and uploading a long list of email addresses to which a web site will automatically send invitations to join a social network. Concurrently, another group of developers may be working on determining which users are most likely to purchase a particular product. Yet another group of developers may be working on predicting which digital content (e.g., a web page) will be viewed most frequently. Thus, each of these three groups working on a different problem domain. Each problem domain is likely to rely on very different features to train a respective computer model. Thus, a different data mart may be created (by someone familiar with the problem domain) for each group of developers.

### Example Process

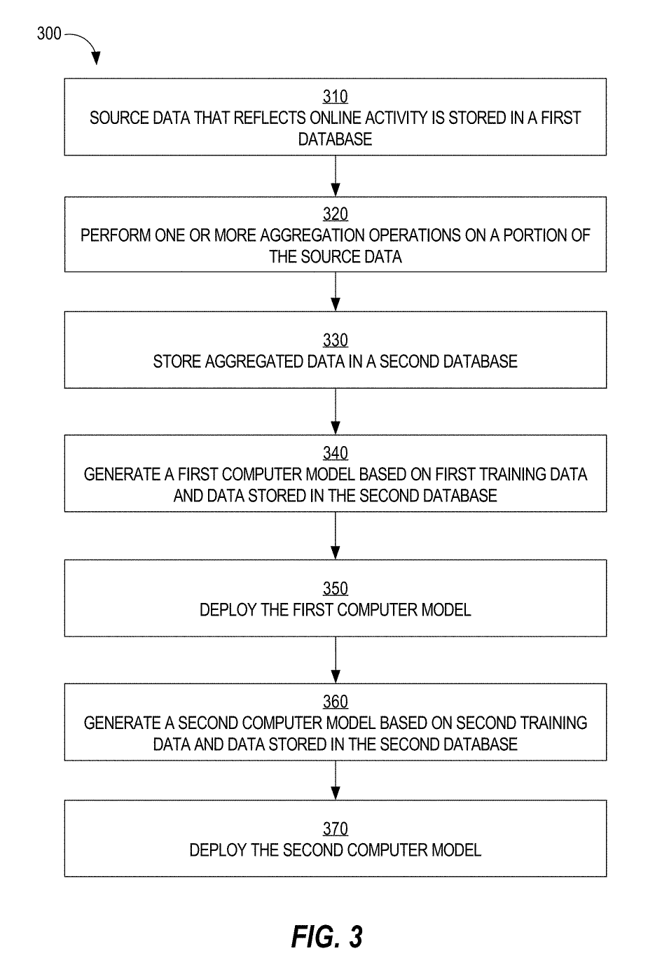

FIG. 3 is a flow diagram that depicts a process 300 for building and using a data mart, in an embodiment. Process 300 may be implemented using different components of system 100, such as driver 118 of ML service 110, input 158, and jobs 164.

At block 310, source data that reflects online activity related to multiple users is stored in a first database. In addition to online activity, the source data may reflect current member profile data.

At block 320, one or more aggregations are performed on a portion of the source data to generate aggregated data that corresponds to one or more features. Example aggregation operations include sum, average, median, and mode.

At block 330, the aggregated data is stored in a second database that includes feature data of multiple features that includes the one or more features. An example of the second database is data mart 156.

At block 340, a first computer model is generated based on first training data and the feature data stored in the second database. Any technique for generating and training the first computer model may be used.

At block 350, the first computer model is deployed. Block 350 may involve sending a job (automatically or with multiple user inputs) to model application system 150.

At block 360, a second computer model is generated based on second training data and the feature data stored in the second database. The second training data may be different than the first training data. For example, the second training data may be known online activity over a more recent time period than the known online activity reflected in the first training data.

At block 370, the second computer model is deployed.

The data in the second database may change over time. Therefore, the second database may contain, at the time the second computer model is generated, feature data that is different than the feature data contained in the second database when the first computer model was generated, as explained in more detail below. In other words, the second database may have been updated between blocks 340 and 360.

### Updating A Data Mart

In an embodiment, a data mart is updated based on recent activity or other changes. A data mart may be updated in at least one of two ways. In one way, new activity occurs, where the new activity pertains to features that are already defined for the data mart. The updating may be performed by a job executing on cluster system 150. Such a job is referred to herein as a “data mart manager.”

For example, the data mart manager receives a record that indicates recent activity. The record may be one of multiple copies that are processed by system 100. The data mart manager determines a type of action indicated in the record and a member identifier that identifies a member. Based on this information, the data mart manager identifies, within data mart 156, a member-specific record that pertains to the type of action and updates the member-specific record based on the value indicated in the received record.

For example, if a first member sends a message to a second member in a social network, then a change record is created that indicates the action (sending a message) and the first member. The data mart manager identifies a member-specific record that identifies the first member and corresponds to the indicated action. The member-specific record in data mart 156 is updated to reflect the sending of the message, such as incrementing a number of messages the first member sent.

Data mart 156 may be partitioned or otherwise organized based on features, such that records pertaining to a first feature are stored (logically or physically) in one storage location while records pertaining to a second feature are stored in another storage location (whether on the same storage medium as the first feature or on a different storage medium).

Some change records may not correspond to any features that are stored in data mart 156. Thus, the data mart manager may receive a change record that does not correspond to any feature. Thus, the data mart manager compares one or more attributes of a change record with feature definition data. If there is not a match, then the data mart manager determines not to process the change record. For example, the data mart manager receives a change record that pertains to a particular profile attribute. The data mart manager then determines whether the particular profile attribute matches a profile attribute indicated in the feature definition data. If not, then the data mart manager ignores the change record.

As another example of how current features may be updated, some features are time-based. Thus, over time, records that correspond to those features “age” and become out of date. For example, one feature is a number of times a member visited a particular webpage in the last week. If a member visited the particular webpage on day 1, but not later, then data mart 156 should reflect, by day 8, that the member has not visited the particular webpage in the last week. Therefore, the data mart manager identifies records corresponding to time-based features and determines which records to update, such as decrementing counts.

Another way a data mart may be automatically updated is through the inclusion of new features. Examples of new features include a newly-defined profile attribute, a newly-defined type of action, a newly-defined web page, a new aggregation operation on an existing feature, or a new product. The data mart manager maintains (or has access to) one or more lists of existing features and determines whether a new feature has been defined. If so, then the data mart manager updates one of the lists. For example, a new web page is created and hosted by system 100 (or an affiliated system). Each web page is uniquely identified by a page key. Then, the data mart manager receives a change record that indicates a particular member and includes a page key of the new page and compares the page key against a list of page keys. If the page key is not in the list, then the data mart manager adds the page key to the list of page keys, creates a new record that indicates the page key and a member identifier that identifies the particular member that viewed the new page, and stores the new record in data mart 156. If different features are stored in different tables, then the data mart manager creates a new table for the new page and the new record stored therein. Future change records that pertain to the new page will have corresponding records stored in that new table. If one feature corresponds to aggregated data (e.g., number of visits to a particular page over a certain period of time), then multiple change records may correspond to a single record in data mart 156.

As another example, an online service (e.g., that maintains and operates system 100) develops a new product and sells that new product to users of the online service. The data mart manager, instead of updating feature definition data in response to receiving a change record indicating the purchase of the new product by a particular user, compares a feature definition list of products (that are reflected in data mart 156) with a current list of products, which list may be maintained by a different component of system 100. If the current list indicates a product that is not in the feature definition list, then the feature definition list is updated to identify that product. Thereafter, the same or different job is executed to process any change records that indicate a purchase of that product.

### Initiating Model Generation

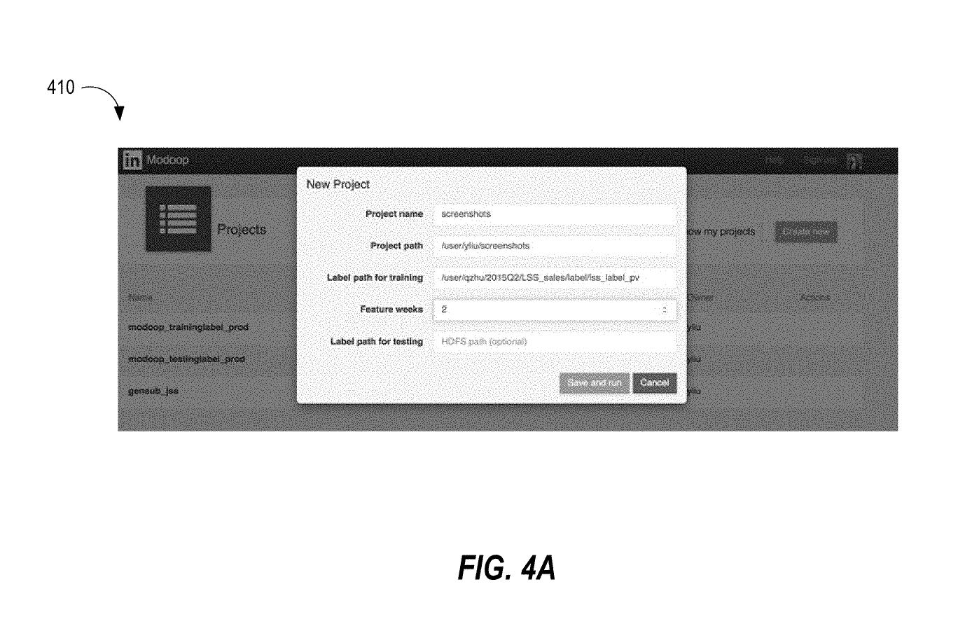

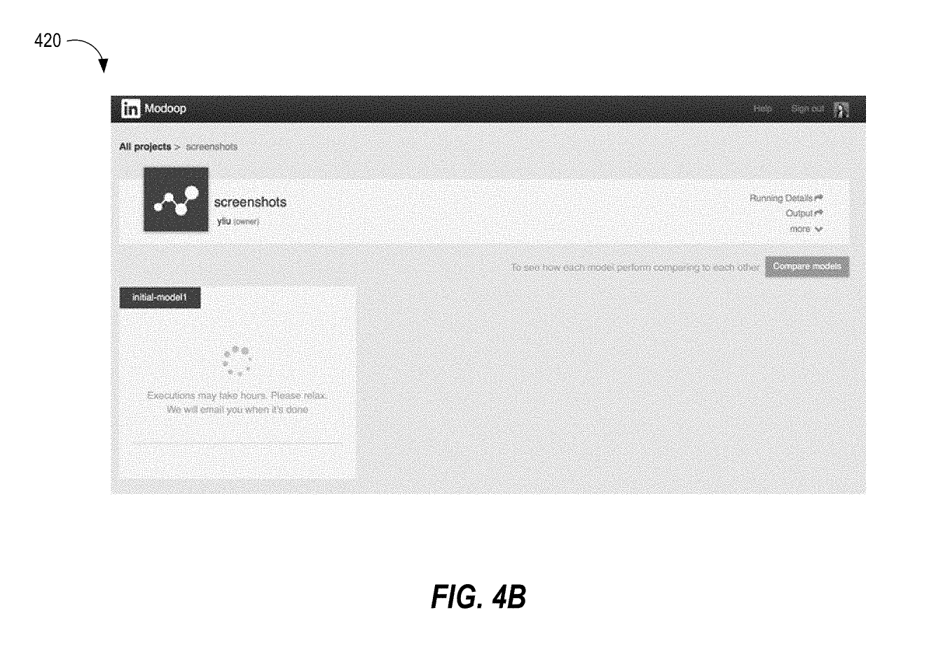

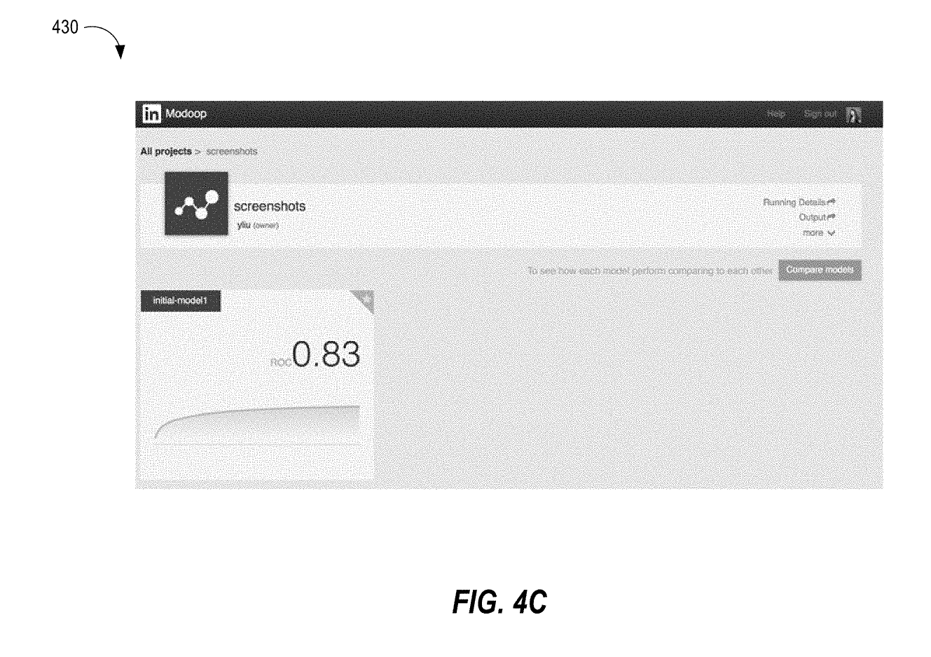

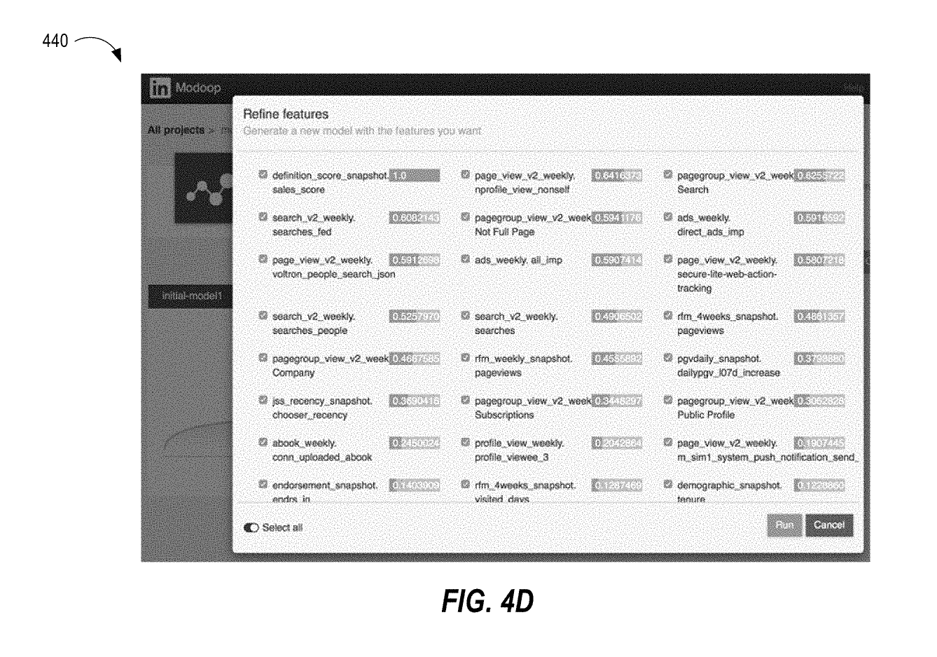

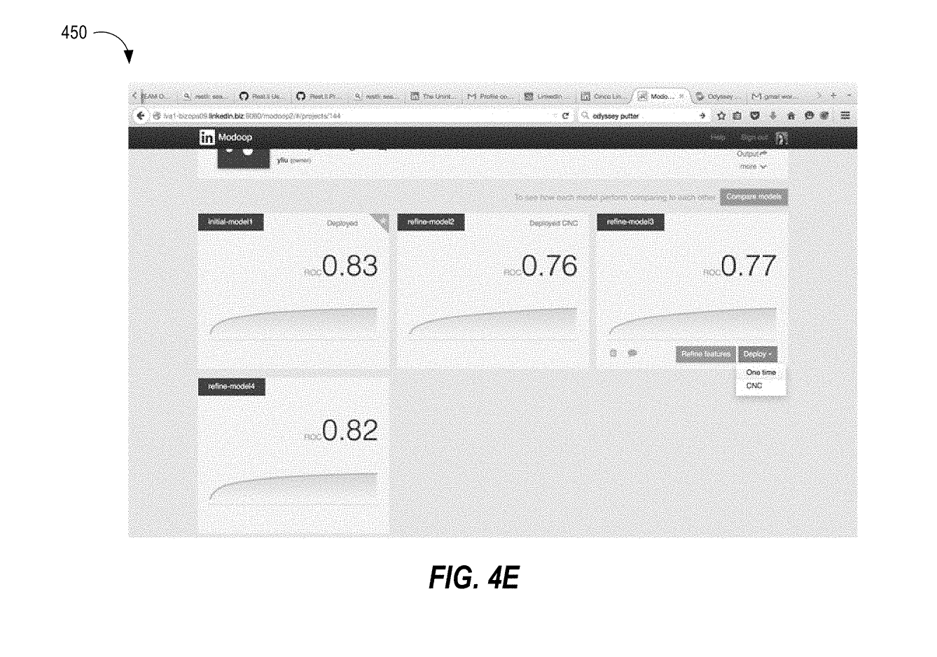

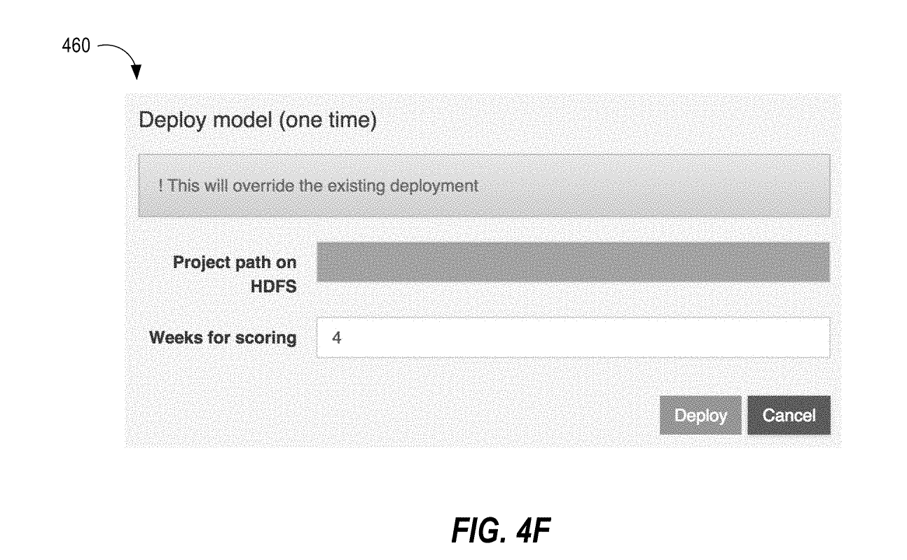

Generation of a computer model may be initiated in one of multiple ways. FIG. 4A is a screenshot of an example user interface 410 that accepts one or more user inputs. In the depicted example, a user provides a project name of the project corresponding to the computer model, a project path that indicates where one or more results of the training phase and/or validation phase are to be stored, a label training path that indicates where labeled training data is stored, “feature weeks” that indicates a number of weeks of data to consider when generating the computer model, and a label testing path that indicates where labeled testing data is stored. If the user doesn't provide input into this label testing path field, then system 100 will select the labeled testing data from the labeled training data.

Thus, in the depicted example, multiple inputs are used to initiate generation of a computer model. Alternatively, default values or settings may exist for one or more of the above inputs. Thus, all that a user may need to provide is a path of where the training data is stored, or a number of weeks, or a path of where results of the computer model while deployed are to be stored. Alternatively, none of the inputs are required other than a user selecting a graphical “Run” button, such as “Save and Run” button. Thereafter, a computer model is automatically generated and, optionally, automatically deployed without the user having to provide any input or any significant input, such as one or more commands (e.g., specified in a query language) to extract data, aggregate data for a feature, or combine data from different features.

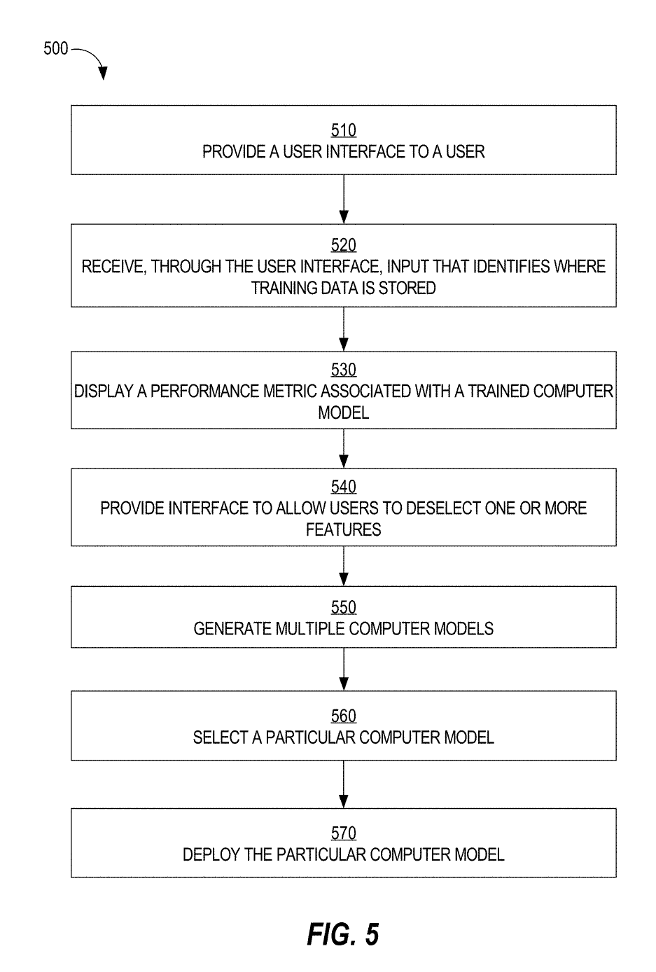

FIG. 5 is a flow diagram that depicts a process 500 for generating and deploying a computer model, in an embodiment. Process 500 may be performed by multiple components of system 100.

At block 510 a user interface (e.g., user interface 112) that allows a user to specify a location where training data is stored is displayed on a client device (not depicted in FIG. 1), such as a laptop computer, a tablet computer, a desktop computer, or a smartphone. The user interface may be provided through a browser (executing on the client device) that sends, over a network (e.g., a LAN or WAN, such as the Internet) to a server, a (e.g., HTTP) request that responds with user interface data that the browser processes to render the user interface. Alternatively, a client application (as opposed to a browser) is downloaded and executed on the client device and is configured to communicate with the server for the user interface data.

At block 520, input that identifies a particular location (e.g., a series of directory or folder names) where particular training data is stored is received through the user interface. Alternatively, the location of training data may be a default location and the user is responsible for storing the training data in the default location, which is known to ML service 110 prior to process 500. In either case, block 520 may involve the user selecting a “Run” button included in the user interface, similar to the “Save and Run” button in FIG. 4A.

After block 520 and before block 530, the user interface may be updated to indicate that a computer model is in process of being trained. An example of such an updated user interface is user interface 420 in FIG. 4B.

In an embodiment, database 116 in ML service 110 stores data about each of one or more projects. A project is initiated by a user and corresponds to one or more computer models that were trained based on an instance of data mart 156 and, optionally, to a selected computer model. A project may have been implemented by a single job or by multiple jobs. Database 116 comprises a table or other mapping that stores project-related information, such as a project ID, location data, and a status field. Location data indicates where results (if any) of the validation phase and/or of the deployment phase are stored. Message processor 114 may use the location data to retrieve the results automatically and send the results to user interface 112 for display to a user. Alternatively, message processor 114 uses the location data to retrieve the results in response to receiving input from the user through user interface 112. Examples of the status field include “Running,” “Failed,” or “Success.” “Running” indicates that the process (for generating/validating/testing/deploying a computer model) associated with corresponding project is still in progress. “Failed” indicates that the process for generating or deploying a computer model has ended. A failure message may further indicate when the failure occurred, such as during feature integration, feature engineering, training, validation, or testing. “Success” indicates that a computer model generated through the corresponding project has been deployed.

Driver 118 reads from and writes data to database 116. Example data includes results of the status or progress of a project, results of a validation phase, results of a testing phase, and results (e.g., success rate) of a deployed model.

Driver 118 also creates customized job settings 126 based on common configurations 120, machine learning libraries 122, and additional library 124. Customized job settings 126 is used to generate a project that includes one or more workflows. A workflow comprises one or more operations that are related to each other. If multiple operations are included in a workflow, then some operations may be performed serially while other operations may be performed concurrently. An example of serial operations are a model training operation followed by a model validation operation. However, a model validation operation applied to one computer model may be performed concurrently with a model validation operation that is applied to another computer model.

While only one driver 118 is depicted, ML service 110 may include multiple drivers, each configured to perform a different set of one or more actions.

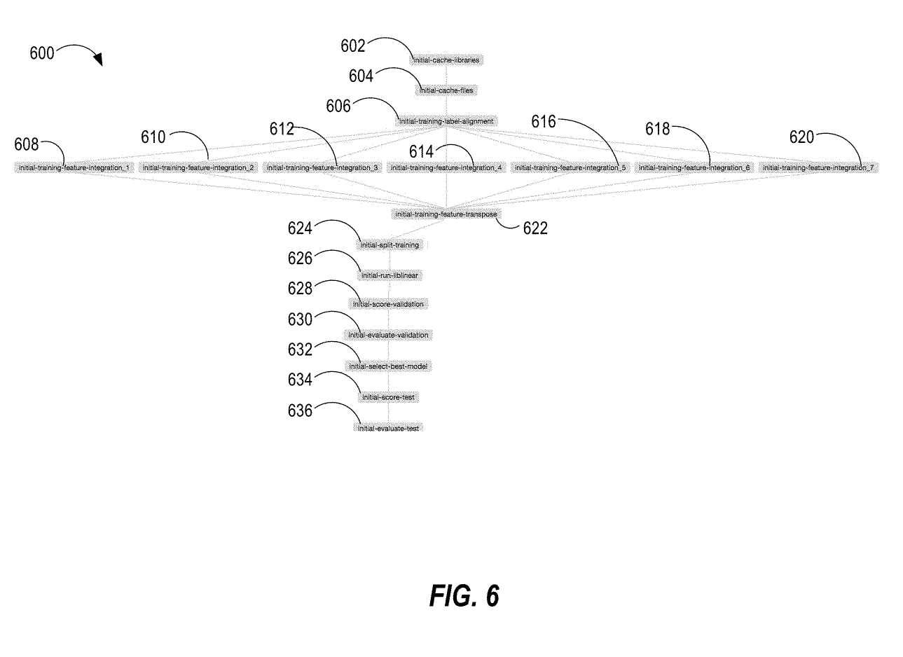

FIG. 6 is a block diagram that depicts an example workflow 600 of a project that ML service 110 creates automatically based on one or more user inputs, in an embodiment. Each node in workflow 600 corresponds to a different program or set of instructions that are part of the project, which may be stored as one or more files. For example, node 602 corresponds to a cache library program that uploads libraries for data operation and model building, node 604 corresponds to a cache files program that uploads a feature list and data schemas, and node 606 corresponds to a training label alignment program that aligns the date attribute of the training label data to a particular day (e.g., the last Saturday) in order to join with the feature data which uses that particular day as the date attribute.

Workflow 600 also includes nodes 608-620 corresponding to programs that perform feature integration and that may be performed concurrently. Nodes 608-620 are followed by node 622, which corresponds to a program that performs one or more transformations on the integrated features produced by nodes 608-620. Node 624 corresponds to a program that splits training data into two or more parts. Node 626 corresponds to a program that uses liblinear to train one or more computer models (using different parameters). Liblinear stands for “Library for Large Linear Classification.” Other embodiments use different machine learning techniques. Node 628 corresponds to a program that validates the computer model(s) that have been trained by running the computer model(s) against a portion of the training data (or “validation data”). Output from this program may include one or more performance metrics. Node 630 corresponds to a program that evaluates one or more computer models based on the one or more performance metrics. Node 632 corresponds to a program that selects the best performing computer model. Node 634 corresponds to a program that tests the best performing computer model based on, for example, another portion of the original training data. Output of this program may include another performance metric. Node 636 corresponds to a program that evaluates the result of the test, such as whether the performance metric is above a particular performance threshold.

Returning to FIG. 1, common configurations 120 include configuration data that is shared by all model training sessions, such as waiting for the (e.g., weekly) integration of multiple features before training a new computer model and procedures to align the data attribute of a training label data, to join the training label data with feature data, and to split the training data for model training, validation, testing, and, optionally, deployment. Examples of customizations (or configurations that tend to change from one model training session to another) include the number of weeks of data needed to train the computer model(s), where the training data is stored, where the testing data is stored, and where to store results of validation, testing, and/or scoring live data. Machine learning libraries 122 include one or more libraries, such as liblinear or libsvm, which libraries are used to generate nodes 624-636 in workflow 600. Additional library 124 generates nodes 608-622 based on input that indicates where the training data is stored, where integrated data is stored, and which weeks to consider to train one or more computer models.

Returning to FIG. 5, at block 530 (which is optional in the embodiment of process 500), a performance metric associated with the trained computer model, as part of the validation stage, is displayed. Block 530 may involve cluster system 150 executing one or more nodes in workflow 600 (e.g., nodes 628-634) that determines that the selected computer model passed a test. Execution of one of the nodes causes an API call to be made to ML service 110, which is received by message processor 114. Message processor 114 stores the result indicated in the API call in database 116. The API call may indicate a project ID and a status of the model creation, such as “Success.” Additionally, message processor 114 may send, to user interface 112, data about the result indicated in the API call.

FIG. 4C is a screenshot of an example user interface 430 that indicates a performance metric for a computer model after the computer model has been validated. The performance metric in this example is a ROC (receiver operating characteristic) curve.

At block 540 (which is optional in the embodiment of process 500), the user is prompted to provide input, such as identifying features to remove from a set of features upon which the multiple computer models are based. FIG. 4D is a screenshot of an example user interface 440 that displays multiple features and an option for each feature to remove that feature from the set of features from which future computer models will be trained. Feature selection is described in more detail below.

At block 550, after receiving the input (of block 520 or 540), multiple computer models are generated based on the particular training data and multiple sets of parameter values. The multiple computer models include at least two computer models that are generated without receiving any user input between generation of the two computer models.

At block 560, a particular model from among the multiple computer models is selected. Block 560 may be performed automatically based on an automatic analysis of the results of validating each of the computer models.

Alternatively, block 560 may involve displaying results of validating each computer model and allowing the user to select one of the computer models. FIG. 4E is a screenshot of an example user interface 450 that indicates results of validating multiple computer models, some of which may be refined versions of an initial model. The refined models may be models that are trained on less features than the initial model. In the depicted example, two of the computer models are deployed and two have not yet been. In this example, a “Deploy” button is displayed adjacent to one of the results due to a mouse over. Alternatively, each result of a non-deployed model includes a Deploy button regardless of a mouse over event. When selected by a user, the Deploy button causes the corresponding computer model to be deployed. Also in this example, a “Refine features” button is displayed adjacent to one of the results. Selection of this button causes an interface to be displayed that allows the user to deselect some features upon which the corresponding computer model was built and/or select additional features upon which the corresponding computer model was not built.

A block 570, the particular model is deployed to a target computer system, such as cluster system 150. Parameter setting, model selection, and model deployment are described in more detail below.

### Feature Integration

Traditionally, a user that wishes to create a computer model not only specifies what features to extract from one or more sources and how some of the features are to be aggregated to create new features, but also specifies how the features are to be integrated. An example of such integration involves multiple join operations that join different features together (e.g., from different sources or databases) to create a single set of features that is used to train one or more computer models. For example, one feature is related to member message sending activity, another feature is related to member demographic information, and another feature is related to member page view history to create a data set that associates each member with their respective message sending activity, demographic information, and page view history. Thus, the join key in this example would be member identifier.

However, manually integrating multiple features is labor intensive and error prone. To compound the problem, an unsophisticated user might not know how the underlying data is stored or how to access that data.

In an embodiment, system 100 automatically combines (or integrates) multiple features into a single data set that can be processed for subsequent feature engineering. There are two parts to feature integration: (1) integrating all the features into a single data structure (referred to herein as “BigTable”) stored in data mart 156, which does not include any training data; and (2) integrating BigTable with labeled training data. Part (1) may be performed regularly (e.g., weekly) and more frequently than part (2). The feature data for part (1) may come from multiple databases (or “mini” data marts), such as one database storing message information about messages sent by multiple users and another database storing page view information about page views initiated by multiple users. Techniques for integrating multiple features is described in U.S. patent application Ser. No. ______, [LI-P1696] which is incorporated herein by reference as if fully disclosed herein.

Part (2) need only be performed when a user initiates the build of a computer model. Part (2) involves a join between BigTable in data mart 156 and the labeled training data. In the context of user data, the join is a join on a user ID or member ID field. Another field upon which the join may be based is date.

In an embodiment, ML service 110 generates a job, passes (e.g., via an API call) the job to job scheduler 162, and cluster system 150 executes the job, which causes feature integration to occur. Feature integration may correspond to one portion of the job, while other portions of the job relate to feature engineering, model training, model validation, and/or model deployment.

### Feature Engineering/Transformation

Traditionally, users who create and train computer models need to manually assign a feature engineering strategy for each desired feature. An example feature engineering strategy is determining a maximum value in a set of feature values, determining a minimum value in a set of feature values, computing a logarithm of a feature value, binarizing a feature value (e.g., any value greater than one becomes one). However, this process is labor-intensive and error prone.

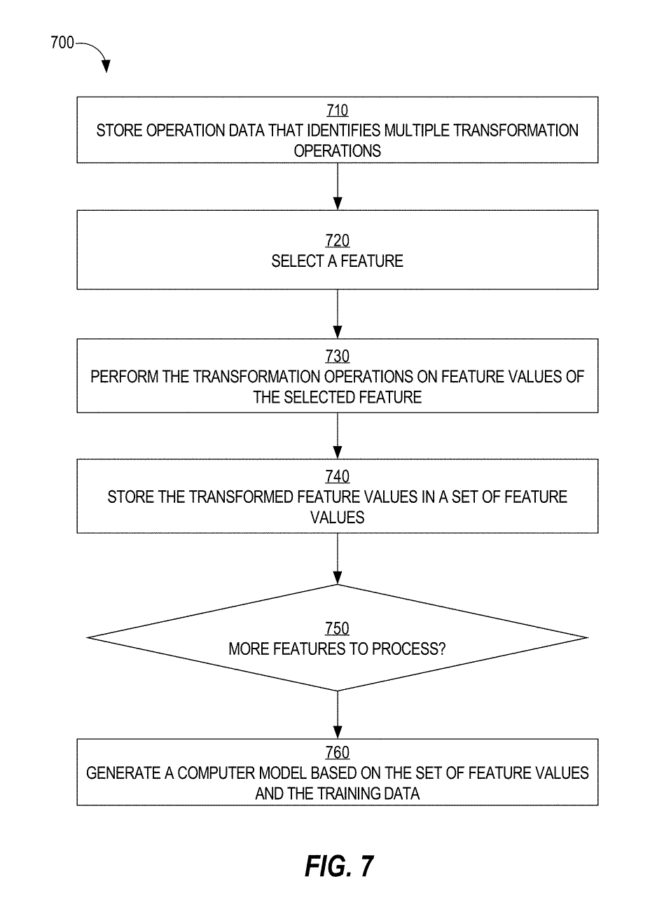

In an embodiment, a feature engineering strategy is pre-defined and automatically applied to a set of features, such as features in data mart 156. An engineering strategy involves applying one or more transformation operations to a set of feature values and occurs after feature integration. There are multiple types of feature transformations that may be added in the future. Therefore, it is flexible to separate feature engineering from feature integration. FIG. 7 is a flow diagram that depicts a process 700 for applying a feature engineering strategy to a set of feature values, in an embodiment. Process 700 is performed by components of system 100.

At block 710, operation data that identifies multiple transformation operations is stored. The transformation operations may include maximum, minimum, average, sum, logarithm, and binary.

At block 720, one of multiple features is selected. While feature transformation is applied to a subset (or all) of the features, the type of transformation operations that are applied to any particular feature may vary depending on the type of that feature.

At block 730, one or more transformation operations are performed on feature values of the selected feature to generate multiple transformed feature values. For example, if five transformation operations are performed on each feature value of a particular feature, then five transformed feature values are generated for each feature value.

An example feature is a number of emails that a user sent in a four week period. If a particular user send out 10, 30, 5, and 15 emails, respectively, in the last four weeks, then applying maximum, minimum, average, and sum to the four week values will result in 30, 5, 17.5, and 60, respectively. Logarithm and binary operations might also be applied to: (a) each week's value (e.g., the logarithm of last week's emails sent would be log(15), binary of first week's emails sent would be 1; and/or (b) an aggregation value (e.g., maximum, minimum, average, sum), such as the logarithm of last 4 weeks (i.e., sum) would be log(60).

At block 740, the transformed feature values are stored in a particular set of feature values. Block 740 may involve storing the transformed feature values separate from data mart 156 and in a place where an executing job (e.g., created by driver 118) reads features values in order to generate and train a computer model.

At block 750, it is determined whether there are any more features that have not yet been selected. If so, then process 700 proceeds to block 720. Otherwise, process 700 proceeds to block 760.

At block 760, the particular set of feature values and training data are used to generate multiple computer models, at least one of which will be selected. Block 760 may be performed by executing a job (e.g., created by driver 118), which is described in more detail below.

### Feature Selection

As described herein, traditionally, user that wishes to generate a computer model is required to know which features the computer model will be based on and how to extract/generate the corresponding feature values.

In an embodiment, features for a computer model are automatically selected. The features are pre-selected and the corresponding values in data mart 156 may be further automatically processed (“engineered”) to generate additional feature values for additional features.

In an embodiment, before a computer model is generated based on features values corresponding to a set of features, a user (e.g., the user that initiated generation of the computer model) is presented with features to “deselect” or remove from the set of features. As noted previously, FIG. 4D is a screenshot of an example user interface 440 that allows a user to deselect features. In this example, user interface 440 displays names of multiple features. A checkbox and an importance metric (ranging from 0 to 1) are displayed adjacent to each feature name. To deselect a feature, a user simply “unchecks” the checkbox. Other implementations may use GUI objects that are different than checkboxes but serve the same purpose to allow a user to remove features from a feature set.

Thus, with user interface 440, a user is allowed to remove features that are counter-intuitive to the context for which the computer model is being built. Thus, if a first user designing data mart 156 is over inclusive of the types of feature values that are extracted from raw sources 152-154, then a second user that desires to generate a computer model based on the values stored in data mart 156 may be more likely to remove features (and, therefore, the corresponding features values) from the final set of feature values upon which the computer model will be generated.

User interface 440 also includes a “Run” button that, when selected by the user, triggers driver 118 (e.g., through user interface 112 and message processor 114) to create a job that, when executed by cluster system 150, determines which features were deselected, identifies the feature values that correspond to the deselected features, removes those feature values from the set of feature values to create a final set of feature values, and generates a computer model based on that final set.

In a related embodiment, user interface 440 is displayed (again or for the first time) after a first set of one or more computer models is generated. The final set of feature values may result in computer models that performed poorly during a validation stage. There may be one or more features (in the final set of feature values) that caused that negative effect. Thus, user interface 440 may be generated and displayed in response to an executing job in cluster system 150 determining that one or more computer models in the first set are associated with performance metrics (described in more detail below) that are below a particular performance threshold.

Additionally, user interface 440 may display, adjacent to some feature names, suggestion data that indicates that the corresponding features are “good” candidates to deselect or remove. After the user deselects one or more features and the set of feature values is updated accordingly, a second set of one or more computer models is generated based on the updated set of feature values. Thus, the updated set of feature values is a strict subset of the previous set of feature values that were used to generate the first set of one or more computer models.

In an alternative embodiment, before a computer model is generated based on the final set of features generated as a result of the feature engineering stage, a user (e.g., the user that initiated generation of the computer model) is presented with a list of features to affirmatively select, as opposed to features to deselect. In this way, a user is given flexibility regarding the set of features upon which a first set of one or more computer models will be based. Later, after the first set of one or more computer models is generated, the set of features that the user selected may be presented to the user again for features to deselect.

### Model Training

Once a final set of feature values is determined, cluster system 150 executes a job to generate one or more computer models using the final set of features and training data, such as training data indicated in user interface 410. An example set of training data is the following:
130182, 2014-12-02, 0
182917, 2014-12-09, 1
289915, 2014-12-02, 1
396415, 2014-12-02, 0
428365, 2014-12-09, 1
503815, 2014-12-02, 0
591642, 2014-12-02, 0
676092, 2014-11-25, 1
722142, 2014-12-09, 1
893892, 2014-12-02, 0

In this example, each row includes a member identifier (e.g., 130182), a date (e.g., 2014-12-02), and an indication of whether the identified member performed a target action, such as purchasing a particular product (or “conversion”), which the training data does not have to specify.

Traditionally, a user initiating generation of a computer model was required to specify which portion of the training data is to be used for training and which is to be used for validation. In an embodiment, ML service 110 (or a job executing on cluster system 150) automatically determines which portion of training data will be used for training and which portion will be used for validation. For example, the last third of the training data is selected and reserved for validation. Thus, that portion is not used for training. As another example, every third entry in the training data is selected and reserved for validation.

In a related embodiment, training data is automatically divided into three different sets: one set for training, one set for validating multiple computer models, and one set for testing a (e.g., the best) computer model selected from among the multiple computer models. The sets may be of equal or differing sizes, such as ⅓ for each set or ⅔ for training, ⅙ for validating, and ⅙ for testing. The same method or criteria for dividing the training data into two sets may be used to divide the training data into three sets.

Embodiments are not limited to any type of analysis in order to generate a computer model. One type of analysis that may be used to generate a computer model is regression analysis, which estimates the relationships among variables and includes many techniques for modeling and analyzing several variables. The focus of regression analysis is on the relationship between a dependent variable and one or more independent variables (or “predictors”). In the context of predicting whether a user will purchase a particular product, the dependent variable is the prediction and the independent variables may include features such as a user's employment status, job title, purchase history, skills, academic history, current residence, and gender. Liblinear and Libsvm are example open source machine learning libraries that may be used to generate one or more computer models.

### Automatic Parameter Setting

Training a computer model involves not only analyzing feature values and training data, but also input values for one or more parameters that influence how the computer model is trained. Example parameters include learning rate, regularization, iteration, and termination tolerance. A characteristic of values of such parameters is that the values do not change while the computer model is trained.

In computer modeling, “learning rate” refers to a constant used in error backpropagation learning and other artificial neural network learning algorithms to affect the speed of learning. The mathematics of backpropagation are based on small changes being made to the weights at each step. If the changes made to weights are too large, then the algorithm may “bounce around” the error surface in a counter-productive fashion. In this case, it is necessary to reduce the learning rate. On the other hand, the smaller the learning rate, the more steps it takes to get to a stopping criterion. Example values of the learning rate parameter include 0.1, 1, 10, 100, 1000, etc.

“Regularization” refers to a process of introducing additional information in order to prevent overfitting. Overfitting occurs when a model describes random error or noise instead of the underlying relationship. Overfitting generally occurs when a model is excessively complex, such as having too many parameters relative to the number of observations. A model that has been over fit will generally have poor predictive performance, as it can exaggerate minor fluctuations in the data. The additional information introduced through regularization (e.g., L1 regularization or L2 regularization) is usually of the form of a penalty for complexity, such as restrictions for smoothness or bounds on the vector space norm.

An iteration (or “epoch”) refers to a complete pass through all of the training data. The weights in the neural net may be updated after each data item (or row) in the training data is presented to the net. Alternatively, the weights may be updated just once at the end of the iteration. The number of iterations is used as a measure of the speed of learning. Possible values for the iteration parameter are whole numbers greater than 0.

In an embodiment, a user who is responsible for building a computer model specifies values for each of multiple parameters. After training and validating one computer model, it is determined (whether manually or automatically), based on one or more performance metrics associated with the computer model, whether to deploy the computer model or to train and validate another computer model. Alternatively, a user may specify multiple sets of parameter values, each set for training a different computer model. In this way, multiple computer models may be generated simultaneously. However, in either approach, the user specifying the set(s) of parameter values requires knowledge of what those parameters mean and what range of values for each parameter is acceptable.

In an alternative embodiment, one or more parameter values are pre-defined and used to train one or more computer models. The parameter values are defined prior to a user initiating generation of the one or more computer models. The parameter values may have been defined by a user that is different than the user initiating the model generation and different than the user who defined the data to be extracted from raw data sources 152-154 and stored in data mart 156.

In a related embodiment, multiple sets of parameter values are stored (e.g., in input 158). Each set of parameter values is used to generate and train a different computer model. For example, a first computer model is generated based on a learning rate of two and a second computer model is generated based on a learning rate of three. The same training data is used to generate each computer model.

If multiple computer models are generated, one for each different set of parameter values, then the multiple computer models are generated (and, optionally, validated) in parallel or sequentially. Previously, if a user wanted to create and compare multiple computer models, then the user would have to repeat, for each computer model, each stage of the model generation process, including feature integration, feature engineering, feature selection, and model training. In contrast, the same set of integrated and engineered feature values are used to training multiple computer models without having to generate that set of feature values for each computer model.

### Model Validation

After a computer model is generated, the computer model is validated. Validation involves running the computer model against training-type data, which results in the computer model making multiple predictions. The predictions are then compared to the actual or known answers. One or more performance metrics may be generated during a model validation stage. Example performance metrics include AUC (Area Under of the Curve), accuracy (ACC), average precision (APR), and Precision (PRE). If the user that initiated building of the computer model(s) is sophisticated enough, then the more metrics that are provided to the user, the more information the user has to make an informed decision about whether the computer model(s) is/are sufficient and, if multiple, which computer model to select.

Model validation may be performed by the same job as the job that initiated generation of the computer model or by a different job that ML service 110 generates.

### Model Selection

In the scenario where multiple computer models are generated, after one or more performance metrics are generated for each computer model, a computer model that is associated with the best performance metric is selected.

In an embodiment, a minimum performance threshold is pre-established, such as by the user that created data mart 156, which user is different than the user that initiated generation of the computer model(s). If none of the computer models has a performance metric that is greater than the minimum performance threshold, then none of the computer models are selected for deployment. The user that initiated creation of the computer model(s) may be notified, such as ML service 110 creating and causing to be sent (a) an email message to a registered email account of the user and/or (b) a text message to a registered phone number of the user.

Additionally or alternatively, the user may be notified through user interface 112 that none of the computer models exceeded a minimum performance threshold. User interface 112 may also indicate the performance metrics of multiple computer models and how close the performance metrics are to the minimum performance threshold.

In an embodiment, message processor 114 causes a display to be presented to the user (e.g., through user interface 112), where the display indicates multiple computer models and, for each model, a performance metric associated therewith. The user may then select one of the computer models. For example, the display may include user interface controls that allow the user to view the computer model with the lowest false positive rate or the highest true positive rate at certain thresholds (e.g., between 0 and 1.0). Thus, while a first computer model may have a higher AUC score than a second computer model, the second computer model may have a lower false positive rate at a particular threshold than the false positive rate (at the particular threshold) associated with the first computer model.

### Model Deployment

After a computer model is trained, validated, and (optionally) tested, the computer model is deployed. The computer model may be deployed on cluster system 150 (or another system (not depicted) that has access to a target data set), which will run the computer model.

Model deployment may be initiated based on user input. For example, FIG. 4F is a screenshot of an example user interface 460 that allows a user to specify one or more inputs. In this example, a user is able to specify (1) a project path where results of running the selected computer model will be stored and (2) a number of weeks for scoring. The former field is optional. If optional, then the same project path specified previously (in FIG. 4A) may be used to store the results. Alternatively, there may be default location or folder that system 100 creates for storing the results, in which case the project path field itself is optional.

The latter field in user interface 460 limits the number of (in this example) users for which the computer model will generate a score. Thus, in this example, the selected computer model only scores users who have been active (or who performed a particular action) for the last four weeks. In a related embodiment, user interface 460 allow a user to specify one or more criteria that limits which data items (e.g., user accounts) to score. For example, a user may specify that only users living in the United States and who have a finance degree are to be scored using the selected computer model. The type of criteria will vary based on the problem domain.

Alternatively, model deployment may be triggered and performed automatically. For example, details of deploying the selected model may be specified in a job that ML service 110 generates and passes to cluster system 150 for execution. The job may also include instructions on training computer models, validating the computer models, and selecting a computer model based on performance metrics generated during the validation phase.

In an automatic deployment embodiment, the user specifies the project path and/or the one or more limiting criteria (i.e., that limits which data items the computer model will score) before a computer model is trained, such as at the time of model initiation. In this way, little or no user input is required between model training and model deployment.

In another embodiment, ML service 110 causes a user interface to be displayed (e.g., via user interface 112) that allows a user to manually create a job script that indicates a computer model and to specify one or more instructions for sending the job to the job scheduler 162 executing in cluster system 150. In a hybrid embodiment, a job script is automatically generated (e.g., by ML service 110) and a user provides input that causes the job script to be sent to job scheduler 162 for scheduling on cluster system 150.

Regardless of how or when a job that causes the selected computer model to be deployed is created, as part of executing the job, the computer model reads data from a source, such as data mart 156. The computer model may only be configured to read data organized in the manner found in data mart 156 and may not be configured to read data from, for example, input 158 or raw data sources 152-154. In the context of predicting user behavior, data mart 156 may comprise a set of user/member identifiers and associated features. For each user identifier in the set, the job involves: (1) identifying and computing, such as one or more transformation operations (e.g., aggregating), the relevant feature values as defined by the model; (2) passing the feature values to the computer model; and (3) the computer model generating, based on the feature values, a score, which reflects a prediction of, in the context of user behavior, an action that the corresponding user will take.

Results of each prediction may be stored to output 160. Additionally or alternatively, cluster system 150 causes results to be stored in a database accessible to ML service 110. For example, cluster system 150 calls an API of ML service 110 and sends one or more results to ML service 110, which results are stored locally with respect to ML service 110 and later analyzed to, for example, determine a conversion or accuracy rate of the computer model. In a related example, the same or different job (that runs the computer model) determines the conversion or accuracy rate.

While the computer model may be trained based on the behavior of hundreds of users, the computer model may be used to predict the behavior of thousands or millions of users.

### Model Refreshment

After a computer model is deployed (regardless of how the computer model was generated, trained, and selected) and is being used to make decisions, the performance of the computer model may decline over time.

In an embodiment, a new computer model is automatically generated in response to determining that one or more criteria are satisfied. In other words, no user input is required to initiate generation of the new computer model other than the input used to generate the old computer model. The one or more criteria may be time-based or event-based. An example of a time-based criterion is every week. An example of an event-based criterion is a negative change in performance of the model relative to “live” data. For example, using the computer model may result in an increase of sales of a particular item (e.g., product or service) after one week, but then the number of sales decreases 10% for two consecutive weeks. If the negative change in sales over two weeks is greater than 15%, then a new computer model is generated.

A new computer model may be generated based on training data that is different than the training data of the current (or old) computer model. Some of the training data may be the same. For example, in the context of predicting which users will purchase a new product (or “complete a conversion”), at least a portion of the actual users who purchased the new product are used in the training data. Thus, an old computer model is based on a first set of conversions that occurred over a first period of time, while a new computer model (that may supersede the old computer model) is based on a second set of conversions that occurred over a second period of time that is different than the first period of time.

In an embodiment, a new computer model is generated based on data mart 156. As noted previously, the state of data mart 156 may change over time as feature values change and new features are defined. Thus, the state of data mart 156 when the new computer model is generated may be different than the state of data mart 156 when the old computer model was generated.

### Champion/Challenger

In an embodiment, a new computer model that is generated is used in place of the old computer model. In an alternative embodiment, the new computer model is applied against one portion of “live” data and the new computer model is applied against another portion of the live data. (The live data may be considered one of input 158 and is indicated by a user. For example, the live data may be all (or a portion of) members indicated in a member database, which may be part of cluster system 150.) Thus, both computer models are executed in parallel. For example, in the context of predicting user behavior, the new computer model is applied to 5% of users while the old computer model is applied to 95% of the users.

One or more metrics are used to compare which computer model is performing better. An example metric is conversation rate. A conversion rate may be calculated by dividing the number of conversions by volume (or the number of predictions). If the old computer model is associated with a higher conversion rate relative to the conversion rate associated with the new computer model, then the new computer model is dropped or ceases to be used. If the new computer model results in a higher conversion rate relative to the conversion rate of the old computer model, then the new computer model replaces the old computer model.

Alternatively, instead of replacing the old model entirely, the new model is applied to a higher percentage of users (e.g., 25% v. 5%). The difference in conversion rate may dictate how much the distribution will be changed. At least for some values in a range of conversion rate values, the higher the conversion rate, the higher the percentage of users against which the new conversion model will be applied.

Additionally or alternatively, before replacing the old computer model, dropping the new model, or adjusting the distribution of users, a statistical significance or level of significance is determined. “Level of significance” refers to the likelihood that the random sample chosen (e.g., 5% for the new computer model) is not representative of the population. The lower the significance level, the more confidence exists in replicating the results of the computer models. Typical significance levels include .05 and .01. The value .05 indicates that 95/100 times that the population is sampled, the same result will occur. Similarly, the value .01 indicates that 99/100 times that the population is sampled, the same result will occur.

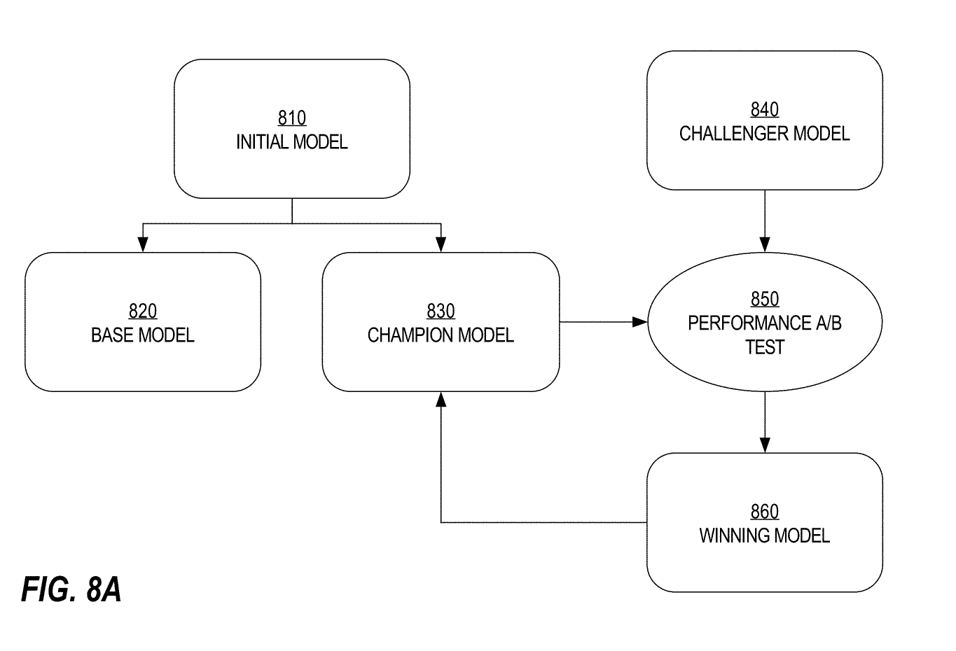

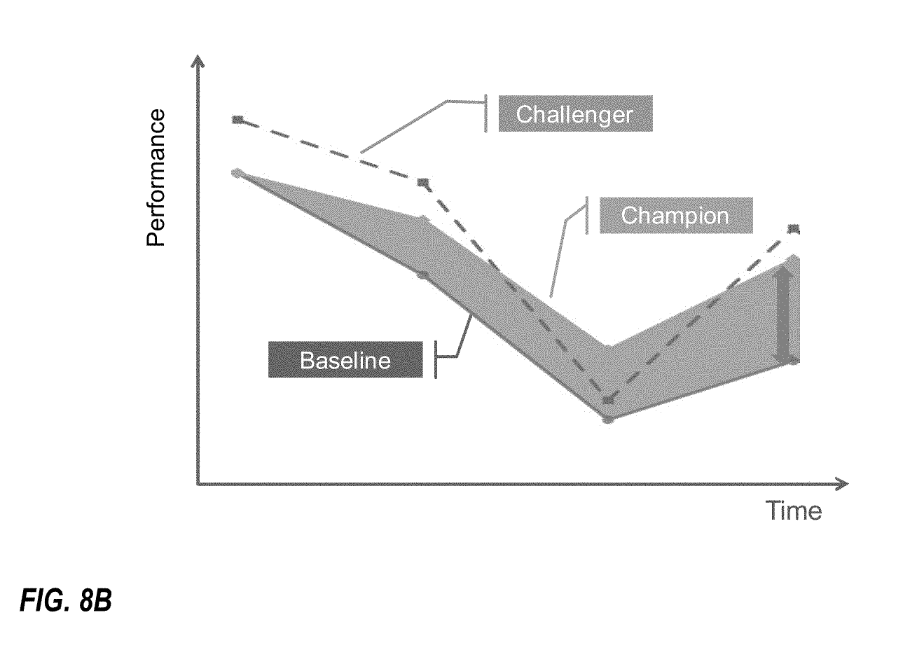

FIG. 8A is a block diagram that depicts an overview of refreshing a computer model, in an embodiment. Initial model 810 by default becomes base model 820 and champion model 830. In other words, base model 820 and champion model 830 are copies of initial model 810. Later, challenger model 840 is generated and may run concurrently with champion model 830. An A/B test 850 is performed (e.g., by a job executing on cluster system 150) and the results of the A/B test are used to select a winning model 860. Winning model 860 then becomes the champion model 830 and the process repeats where a new challenger model 840 is eventually generated. Refreshing a model may be performed without any user input to (a) initiate the process and/or (b) generate the challenger model, perform the A/B test, and select a champion.

FIG. 8B is a chart that depicts performance of three example models over time: a baseline (or initial) model, a champion model, and a challenger model. Initially, a challenger model performs better than the baseline and champion models until time T1. Then, the champion model performs better than the baseline and challenger models until time T2, after which the challenger model performs best. The challenger model may have remain the challenger model if the difference between the performance of the challenger and champion models is not statistically significance. Thus, the bulk of the live data continues to be fed to the champion model. The baseline model may be executed against the same data as the champion model. The area between the champion and baseline models is referred to as the “gain” and indicates how much better the champion model is than the baseline (or original) model.

In a related embodiment, instead of executing a new computer model (or challenger) against live data, the new computer model is executed against prior data, such as data against which the old computer model was executed. For example, a first computer model is deployed and executed against live data during week 1. In week 2, a second computer model that is based on similar data as the first computer model is deployed. However, the second computer model is executed against the data that was “live” during week 1. Such a scenario may be based on user input received through user interface 112 either initially when the first computer model was generated or later while the first computer model (or another intermediate computer model) was deployed. The user input may indicate that a subsequent computer model is to be executed against different or “old” data and, optionally, indicate a specific or relative date range (e.g., “week of 9/1/2015” or “last week”).

### Benefits

Multiple benefits may be realized through implementing one or more embodiments described herein. For example, a manual approach may take 4-6 weeks to generate and deploy a model while, under some embodiments, it only takes a few days or even less than two hours to generate and deploy a model. One factor in the increased efficiency is the establishment of data mart 156 which establishes the core features. Another factor in the increased efficiency is the model training stage where multiple computer models are trained simultaneously.

Another benefit is that ML service 110 builds the pipeline that includes a feature selection stage, a feature integration stage, a feature engineering stage, a model training stage, a model selection stage, a model deployment stage, and a model comparison stage. Thus, a user is not required to build the pipeline, which may take days or weeks.

While the traditional approach allows a user much flexibility at every stage (as a result of the extremely manual nature of the approach), some embodiments herein still allow flexibility in that a user can customize features (e.g., deselect certain features) and parameters (such as a time range of feature data upon which a model will be trained) for advanced usage.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

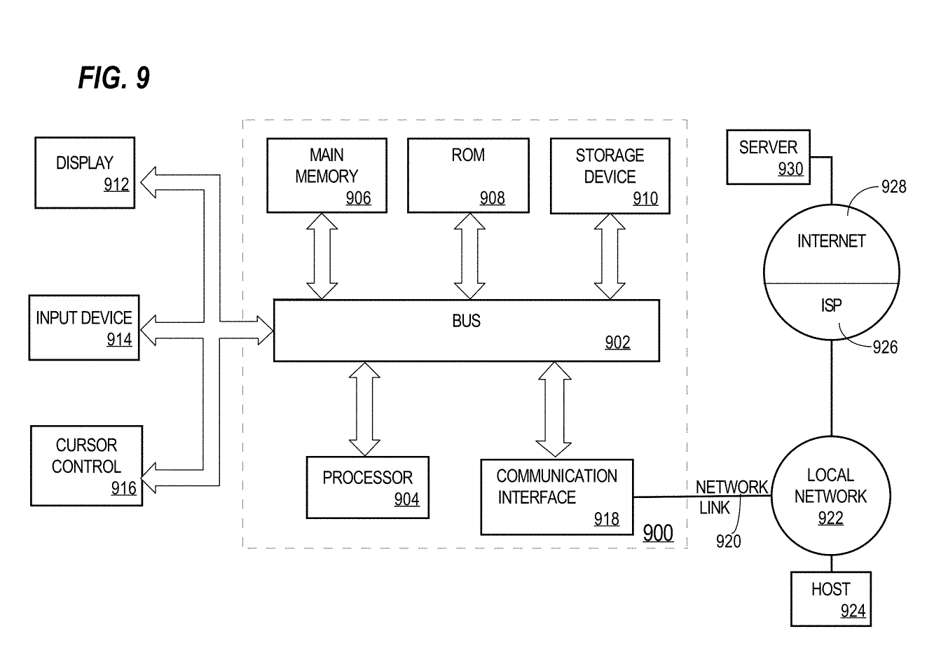

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing, in a first database, source data that reflects first online activity related to multiple users;
performing one or more aggregation operations on at least a portion of the source data to generate aggregated data that corresponds to one or more features;
storing the aggregated data in a second database that comprises first feature data of a plurality of features that includes the one or more features;
generating a first computer model based on the first feature data that is stored in the second database;
causing the first computer model to be deployed;
generating, based on the first feature data that is stored in the second database, a second computer model that is different than the first computer model;
causing the second computer model to be deployed;
wherein the method is performed by one or more computing devices.

2. The method of claim 1, wherein a user that initiated generation of the second computer model did not specify any features to extract from the source data.

3. The method of claim 1, further comprising:
receiving new data that reflects second online activity that occurred after the first online activity;
generating second feature data based on the new data;
updating the database to include second feature data that is different than the first feature data.

4. The method of claim 3, wherein:
generating the first computer model comprises generating the first computer model prior to updating the database;
generating the second computer model comprises generating, after updating database, the second computer model based on the second feature data.

5. The method of claim 1, wherein performing one or more aggregation operations comprises aggregating the first portion of the source data based on time.

6. The method of claim 1, further comprising, prior to performing the one or more aggregation operations:
receiving, from a first source of a plurality of sources, first source data that reflects online activity related to first users;
receiving, from a second source of the plurality of sources, second source data that reflects online activity related to second users.

7. The method of claim 1, further comprising:
prior to performing the one or more aggregation operations, receiving first user input that indicates the one or more aggregation operations and, for each aggregation operation, one or more parameters.

8. The method of claim 7, further comprising:
after generating the first computer model and prior to generating the second computer model:
receiving second user input that indicates a second aggregation operation;
in response to receiving the second user input, performing the second aggregation operation on a portion of data in the first database to generate second aggregated data that corresponds to a second feature;
storing the second aggregated data in the second database;
wherein generating the second computer model comprises generating the second computer model based, at least in part, on the second aggregated data.

9. A method comprising:
causing, to be displayed, a user interface that allows a user to specify a location where training data is stored;
receiving, through the user interface, input that identifies a particular location where particular training data is stored;
after receiving the input:
generating, based on the particular training data and a plurality of sets of parameter values, a plurality of computer models that includes a first model and a second model, wherein generating the plurality of computer models is performed without receiving user input between generating the first model and generating the second model;
selecting a particular model from among the plurality of computer models;
causing the particular model to be deployed to a computing system;
wherein the method is performed by one or more computing devices.

10. The method of claim 9, further comprising:
causing, to be displayed, a second user interface that indicates a plurality of features and allows the user to remove one or more features from the plurality of features, wherein the plurality of computer models are based on a strict subset of the plurality of features.

11. The method of claim 9, wherein no user input is received between generating the plurality of computer models and selecting the particular model.

12. The method of claim 9, wherein no user input is received between selecting the particular model and causing the particular model to be deployed.

13. The method of claim 9, wherein causing the particular model to be deployed comprises:
receiving second input that specifies a job that indicates the particular model;
receiving third input that causes the job to be executed, by a distributed processing software framework, against data about a plurality of entities.

14. The method of claim 9, wherein causing the particular model to be deployed comprises automatically:
generating a job that indicates the particular model;
sending the job from a first system to a second system of a distributed processing software framework, wherein the second system executes the job against data about a plurality of entities.

15. The method of claim 14, wherein sending comprises calling an API of the second system that comprises a job scheduler for scheduling multiple jobs to be executed by the second system.

16. The method of claim 9, wherein causing the particular model to be deployed comprises:
automatically generating a job that indicates the particular model;
receiving second input that causes the job to be executed, by a distributed processing software framework, against data about a plurality of entities.

17. The method of claim 1, wherein:
the user interface allows the user to indicate a time range;
generating the plurality of computer models comprises determining, based on the time range, a set of feature values to use to generate the plurality of computer models;
the plurality of computer models are generated based on the set of feature values.

18. A system comprising:
one or more processors;
one or more storage media carrying instructions which, when executed by the one or more processors, cause:
storing, in a first database, source data that reflects first online activity related to multiple users;
performing one or more aggregation operations on at least a portion of the source data to generate aggregated data that corresponds to one or more features;
storing the aggregated data in a second database that comprises first feature data of a plurality of features that includes the one or more features;
generating a first computer model based on the first feature data that is stored in the second database;
causing the first computer model to be deployed;
generating, based on the first feature data that is stored in the second database, a second computer model that is different than the first computer model;
causing the second computer model to be deployed.

19. The system of claim 18, wherein a user that initiated generation of the second computer model did not specify any features to extract from the source data.

20. The method of claim 18, wherein the instructions, when executed by the one or more processors, further cause:
receiving new data that reflects second online activity that occurred after the first online activity;
generating second feature data based on the new data;
updating the database to include second feature data that is different than the first feature data.
